(19) United States
(12) Patent Application Publication
(10) Pub. No.: US 2017/0052979 A1
(43) Pub. Date: Feb. 23, 2017

(54) Input/Output (IO) Request Processing Method and File Server

(71) Applicant: Huawei Technologies Co., Ltd., Shenzhen (CN)

(72) Inventors: Kai Qi, Hangzhou (CN); Wei Wang, Hangzhou (CN); Keping Chen, Shenzhen (CN)

(21) Appl. No.: 15/346,114

(22) Filed: Nov. 8, 2016

Related U.S. Application Data
(63) Continuation of application No. PCT/CN2014/091935, filed on Nov. 21, 2014.

(51) Int. Cl. G06F 17/30; G06F 9/48

(52) U.S. Cl. CPC G06F 17/30233; G06F 17/30103; G06F 17/30132; G06F 9/4881

(57) ABSTRACT

An input/output (IO) request processing method and a file server, where the method includes adding, according to different service levels carried in IO requests of users, the IO requests of the users to corresponding cache queues for processing at a virtual file system layer, a block IO layer and a device driver layer separately, thereby meeting different service level requirements for the IO requests of the users.

### CROSS-REFERENCE TO RELATED APPLICATIONS

This application is a continuation of International Application No. PCT/CN2014/091935, filed on Nov. 21, 2014, the disclosure of which is hereby incorporated by reference in its entirety.

### TECHNICAL FIELD

The present disclosure relates to the field of electronic information, and in particular, to an input/output (IO) request processing method and a file server.

### BACKGROUND

A LINUX system is a multiuser multitasking operating system that supports multithreading and multiple central processing units (CPUs). File systems in the LINUX system include different physical file systems. Because the different physical file systems have different structures and processing modes, in the LINUX system, a virtual file system may be used to process the different physical file systems.

In other approaches, a virtual file system performs same processing regardless of whether service levels of the IO requests of the users are the same when receiving IO requests of users. As a result, different service level requirements for IO requests of users cannot be met.

### SUMMARY

Embodiments of the present disclosure provide an IO request processing method and a file server in order to resolve a problem in the prior art that different service level requirements for IO requests of users cannot be met.

To achieve the foregoing objective, the following technical solutions are used in the embodiments of the present disclosure.

According to a first aspect, an embodiment of the present disclosure provides an IO request processing method, where the method is applied to a file system, the file system includes a virtual file system layer, a block IO layer, and a device driver layer, the file system further includes a service level information base, and the service level information base includes a first correspondence between a service level of a user and a cache queue at the virtual file system layer, a second correspondence among the service level of the user, a cache queue at the block IO layer, and a scheduling algorithm for scheduling an IO request of the user in the cache queue at the block IO layer, and a third correspondence between the service level of the user and a cache queue at the device driver layer, and the method includes receiving, by the virtual file system layer, an IO request of a first user, where the IO request of the first user carries a service level of the first user, querying for the first correspondence in the service level information base according to the service level of the first user, to determine a cache queue at the virtual file system layer corresponding to the service level of the first user, and adding the IO request of the first user to the determined cache queue at the virtual file system layer, receiving, by the block IO layer, the IO request of the first user from the determined cache queue at the virtual file system layer, querying for the second correspondence in the service level information base according to the service level of the first user, to determine a cache queue at the block IO layer corresponding to the service level of the first user and a scheduling algorithm for scheduling the IO request of the first user, adding the IO request of the first user to the determined cache queue at the block IO layer corresponding to the service level of the first user, and scheduling the IO request of the first user in the cache queue at the block IO layer according to the determined scheduling algorithm for scheduling the IO request of the first user, and receiving, by the device driver layer, the scheduled IO request of the first user from the cache queue at the block IO layer corresponding to the service level of the first user, querying for the third correspondence in the service level information base according to the service level of the first user, to determine a cache queue at the device driver layer corresponding to the service level of the first user, and adding the scheduled IO request of the first user to the determined cache queue at the device driver layer corresponding to the service level of the first user, for processing.

With reference to the first aspect, in a first possible implementation manner of the first aspect, receiving, by the virtual file system layer, an IO request of a second user, where the IO request of the second user carries a service level of the second user, querying for the first correspondence in the service level information base according to the service level of the second user, creating a cache queue at the virtual file system layer for the IO request of the second user according to the service level of the second user when the first correspondence does not include a correspondence between the service level of the second user and the cache queue at the virtual file system layer, creating, by the block IO layer, a cache queue at the block IO layer for the IO request of the second user according to the service level of the second user, determining a scheduling algorithm for scheduling the IO request of the second user in the cache queue that is created at the block IO layer for the IO request of the second user, and creating, by the device driver layer, a cache queue at the device driver layer for the IO request of the second user according to the service level of the second user, where the IO request of the second user is scheduled using the scheduling algorithm determined at the block IO layer.

With reference to the first possible implementation manner of the first aspect, in a second possible implementation manner of the first aspect, the method further includes recording, in the first correspondence in the service level information base, a correspondence between the service level of the second user and the cache queue created at the virtual file system layer for the IO request of the second user, recording, in the second correspondence, a correspondence among the service level of the second user, the cache queue created at the block IO layer for the IO request of the second user, and the scheduling algorithm for scheduling the IO request of the second user in the cache queue that is created at the block IO layer for the IO request of the second user, and recording, in the third correspondence, a correspondence between the service level of the second user and the cache queue created at the device driver layer for the IO request of the second user scheduled using the scheduling algorithm determined at the block IO layer.

According to a second aspect, an embodiment of the present disclosure provides a file server, where the file server runs a file system, the file system includes a virtual file system layer, a block IO layer, and a device driver layer, the file system further includes a service level information base, and the service level information base includes a first correspondence between a service level of a user and a cache queue at the virtual file system layer, a second correspondence among the service level of the user, a cache queue at the block IO layer, and a scheduling algorithm for scheduling an IO request of the user in the cache queue at the block IO layer, and a third correspondence between the service level of the user and a cache queue at the device driver layer, and the file server includes a receiving unit configured to receive an IO request of a first user using the virtual file system layer, where the IO request of the first user carries a service level of the first user, and a processing unit configured to query for the first correspondence in the service level information base according to the service level of the first user, to determine a cache queue at the virtual file system layer corresponding to the service level of the first user, and add the IO request of the first user to the determined cache queue at the virtual file system layer, where the receiving unit is further configured to receive the IO request of the first user from the determined cache queue at the virtual file system layer using the block IO layer. The processing unit is further configured to query for the second correspondence in the service level information base according to the service level of the first user, to determine a cache queue at the block IO layer corresponding to the service level of the first user and a scheduling algorithm for scheduling the IO request of the first user, add the IO request of the first user to the determined cache queue at the block IO layer corresponding to the service level of the first user, and schedule the IO request of the first user in the cache queue at the block IO layer according to the determined scheduling algorithm for scheduling the IO request of the first user. The receiving unit is further configured to receive, using the device driver layer, the scheduled IO request of the first user from the cache queue at the block IO layer corresponding to the service level of the first user, and the processing unit is further configured to query for the third correspondence in the service level information base according to the service level of the first user, to determine a cache queue at the device driver layer corresponding to the service level of the first user, and add the scheduled IO request of the first user to the determined cache queue at the device driver layer corresponding to the service level of the first user, for processing.

With reference to the second aspect, in a first possible implementation manner of the second aspect, the receiving unit is further configured to receive an IO request of a second user using the virtual file system layer, where the IO request of the second user carries a service level of the second user. The processing unit is further configured to query for the first correspondence in the service level information base according to the service level of the second user, and when the first correspondence does not include a correspondence between the service level of the second user and the cache queue at the virtual file system layer, create a cache queue at the virtual file system layer for the IO request of the second user according to the service level of the second user. The processing unit is further configured to create, using the block IO layer, a cache queue at the block IO layer for the IO request of the second user according to the service level of the second user, and determine a scheduling algorithm for scheduling the IO request of the second user in the cache queue that is created at the block IO layer for the IO request of the second user, and the processing unit is further configured to create, using the device driver layer, a cache queue at the device driver layer for the IO request of the second user according to the service level of the second user, where the IO request of the second user is scheduled using the scheduling algorithm determined at the block IO layer.

With reference to the first possible implementation manner of the second aspect, in a second possible implementation manner of the second aspect, the file server further includes a storage unit configured to record, in the first correspondence in the service level information base, a correspondence between the service level of the second user and the cache queue created at the virtual file system layer for the IO request of the second user, record, in the second correspondence, a correspondence among the service level of the second user, the cache queue created at the block IO layer for the IO request of the second user, and the scheduling algorithm for scheduling the IO request of the second user in the cache queue that is created at the block IO layer for the IO request of the second user, and record, in the third correspondence, a correspondence between the service level of the second user and the cache queue created at the device driver layer for the IO request of the second user scheduled using the scheduling algorithm determined at the block IO layer.

According to a third aspect, an embodiment of the present disclosure provides a file server, where the file server runs a file system, the file system includes a virtual file system layer, a block IO layer, and a device driver layer, the file system further includes a service level information base, and the service level information base includes a first correspondence between a service level of a user and a cache queue at the virtual file system layer, a second correspondence among the service level of the user, a cache queue at the block IO layer, and a scheduling algorithm for scheduling an IO request of the user in the cache queue at the block IO layer, and a third correspondence between the service level of the user and a cache queue at the device driver layer, and the file server includes a processor, a bus, and a memory, where the processor and the memory are connected using the bus. The processor is configured to receive an IO request of a first user using the virtual file system layer, where the IO request of the first user carries a service level of the first user, query for the first correspondence in the service level information base according to the service level of the first user, to determine a cache queue at the virtual file system layer corresponding to the service level of the first user, and add the IO request of the first user to the determined cache queue at the virtual file system layer. The processor is further configured to receive the IO request of the first user from the determined cache queue at the virtual file system layer using the block IO layer, query for the second correspondence in the service level information base according to the service level of the first user, to determine a cache queue at the block IO layer corresponding to the service level of the first user and a scheduling algorithm for scheduling the IO request of the first user, add the IO request of the first user to the determined cache queue at the block IO layer corresponding to the service level of the first user, and schedule the IO request of the first user in the cache queue at the block IO layer according to the determined scheduling algorithm for scheduling the IO request of the first user, and the processor is further configured to receive, using the device driver layer, the scheduled IO request of the first user from the cache queue at the block IO layer corresponding to the service level of the first user, query for the third correspondence in the service level information base according to the service level of the first user, to determine a cache queue at the device driver layer corresponding to the service level of the first user, and add the scheduled IO request of the first user to the determined cache queue at the device driver layer corresponding to the service level of the first user, for processing.

With reference to the third aspect, in a first possible implementation manner of the third aspect, the processor is further configured to receive an IO request of a second user using the virtual file system layer, where the IO request of the second user carries a service level of the second user. The processor is further configured to query for the first correspondence in the service level information base according to the service level of the second user, and when the first correspondence does not include a correspondence between the service level of the second user and the cache queue at the virtual file system layer, create a cache queue at the virtual file system layer for the IO request of the second user according to the service level of the second user. The processor is further configured to create, using the block IO layer, a cache queue at the block IO layer for the IO request of the second user according to the service level of the second user, and determine a scheduling algorithm for scheduling the IO request of the second user in the cache queue that is created at the block IO layer for the IO request of the second user, and the processor is further configured to create, using the device driver layer, a cache queue at the device driver layer for the IO request of the second user according to the service level of the second user, where the IO request of the second user is scheduled using the scheduling algorithm determined at the block IO layer.

With reference to the first possible implementation manner of the third aspect, in a second possible implementation manner of the third aspect, the memory is further configured to record, in the first correspondence in the service level information base, a correspondence between the service level of the second user and the cache queue created at the virtual file system layer for the IO request of the second user, record, in the second correspondence, a correspondence among the service level of the second user, the cache queue created at the block IO layer for the IO request of the second user, and the scheduling algorithm for scheduling the IO request of the second user in the cache queue that is created at the block IO layer for the IO request of the second user, and record, in the third correspondence, a correspondence between the service level of the second user and the cache queue created at the device driver layer for the IO request of the second user scheduled using the scheduling algorithm determined at the block IO layer.

According to the IO request processing method and the file server that are provided in the embodiments of the present disclosure, a virtual file system layer receives an IO request of a first user, and adds the IO request of the first user to a cache queue that is determined at the virtual file system layer according to a service level of the first user, a block IO layer receives the IO request of the first user from the determined cache queue at the virtual file system layer, adds the IO request of the first user to a determined cache queue at the block IO layer corresponding to the service level of the first user, and schedules the IO request of the first user in the cache queue at the block IO layer according to a determined scheduling algorithm for scheduling the IO request of the first user, and a device driver layer receives the scheduled IO request of the first user from the cache queue at the block IO layer corresponding to the service level of the first user, and adds the scheduled IO request of the first user to a determined cache queue at the device driver layer corresponding to the service level of the first user, for processing, thereby meeting different service level requirements for IO requests of users.

### BRIEF DESCRIPTION OF DRAWINGS

To describe the technical solutions in the embodiments of the present disclosure more clearly, the following briefly describes the accompanying drawings required for describing the embodiments.

FIG. 1 is a schematic structural diagram of a file system according to an embodiment of the present disclosure;

FIG. 2 is a schematic flowchart of an IO request processing method according to an embodiment of the present disclosure;

FIG. 3 is a schematic flowchart of an IO request processing method according to another embodiment of the present disclosure;

FIG. 4 is a schematic flowchart of an IO request processing method according to an embodiment of the present disclosure;

FIG. 5 is a schematic structural diagram of a file server according to an embodiment of the present disclosure; and

FIG. 6 is a schematic structural diagram of a file server according to another embodiment of the present disclosure.

### DESCRIPTION OF EMBODIMENTS

The following clearly describes the technical solutions in the embodiments of the present disclosure with reference to the accompanying drawings in the embodiments of the present disclosure.

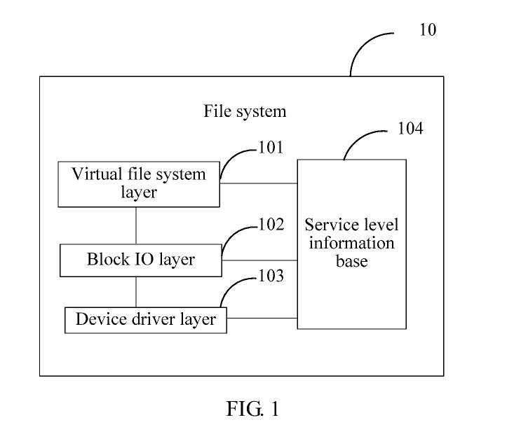

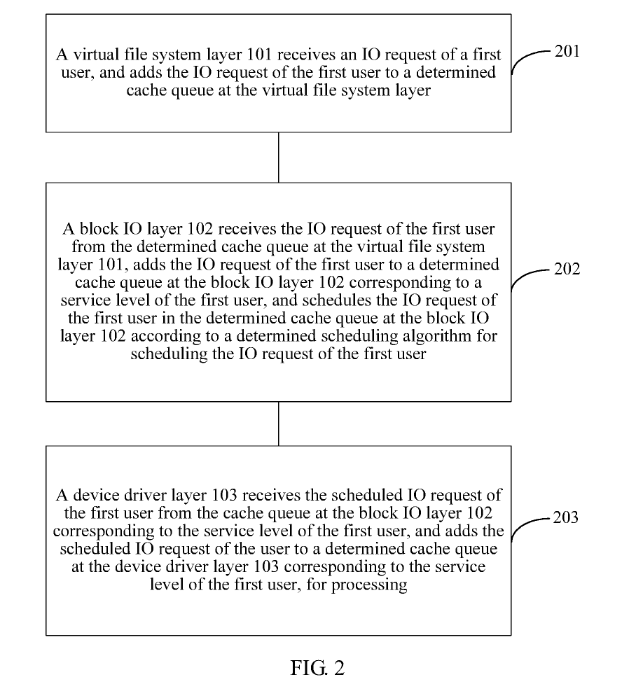

An embodiment of the present disclosure provides an IO request processing method, where the method is applied to a file system. A structure of a file system 10 is shown in FIG. 1, and includes a virtual file system layer 101, a block IO layer 102, and a device driver layer 103. The file system 10 may further include a service level information base 104, and the service level information base 104 may include a first correspondence between a service level of a user and a cache queue at the virtual file system layer 101, a second correspondence among the service level of the user, a cache queue at the block IO layer 102, and a scheduling algorithm for scheduling an IO request of the user in the cache queue at the block IO layer 102, and a third correspondence between the service level of the user and a cache queue at the device driver layer 103. Exemplarily, a file server runs the file system 10 to implement the IO request processing method. Optionally, the file server may be a universal server that runs the file system 10, or another similar server, which is not limited in this embodiment of the present disclosure. As shown in FIG. 2, the IO request processing method provided in this embodiment of the present disclosure is implemented when the file server receives the IO request of the user. Details are as follows.

Step 201: The virtual file system layer 101 receives an IO request of a first user, and adds the IO request of the first user to a determined cache queue at the virtual file system layer 101.

The IO request of the first user carries a service level of the first user, that is, the IO request of the first user needs to meet the service level of the first user. Optionally, the service level of the first user is a service level, of the first user, in a service level agreement (SLA).

The SLA is an agreement officially elaborated through negotiation between a service provider and a service consumer, and records a consensus reached between the service provider and the service consumer on a service, a priority, a responsibility, a guarantee, and a warranty. The service level of the first user may also be a service level determined for each user according to performance of the file server. According to a service level of a user, the file server provides corresponding processing performance. The user in this embodiment of the present disclosure may be an application program, a client, a virtual machine, or the like, which is not limited in this embodiment of the present disclosure.

With reference to the file system 10 corresponding to FIG. 1, the virtual file system layer 101 may query for the first correspondence in the service level information base 104 according to the service level of the first user, to determine a cache queue at the virtual file system layer 101 corresponding to the service level of the first user, and add the IO request of the first user to the determined cache queue at the virtual file system layer 101.

Optionally, the first correspondence, the second correspondence, and the third correspondence that are corresponding to the IO request of the first user can be queried for in the service level information base 104 using a query method such as a sequence query, a dichotomic query, a hash table method, or a block query. Herein, a specific method used to implement a query in the service level information base 104 is not limited in this embodiment of the present disclosure.

Further, the service level information base 104 may include the first correspondence between the service level of a user and the cache queue at the virtual file system layer 101, the second correspondence among the service level of the user, the cache queue at the block IO layer 102, and the scheduling algorithm for scheduling the IO request of the user in the cache queue at the block IO layer 102, and the third correspondence between the service level of the user and the cache queue at the device driver layer 103. In other words, for an IO request of each user, there are a first correspondence, a second correspondence, and a third correspondence in the service level information base 104. Optionally, the first correspondence, the second correspondence, and the third correspondence that are corresponding to the IO request of each user and stored in the service level information base 104 can be stored in the service level information base 104 in a form of list.

Step 202: The block IO layer 102 receives the IO request of the first user from the determined cache queue at the virtual file system layer 101, adds the IO request of the first user to a determined cache queue at the block IO layer 102 corresponding to a service level of the first user, and schedules the IO request of the first user in the determined cache queue at the block IO layer 102 according to a determined scheduling algorithm for scheduling the IO request of the first user.

With reference to the file system 10 corresponding to FIG. 1, the block IO layer 102 can receive the IO request of the first user from the determined cache queue at the virtual file system layer 101, and query for the second correspondence in the service level information base 104 according to the service level of the first user. The second correspondence is a correspondence among the service level of the user, the cache queue at the block IO layer 102, and the scheduling algorithm for scheduling the IO request of the user in the cache queue at the block IO layer 102.

Further, the block IO layer may query for the second correspondence in the service level information base 104 according to the service level of the first user, to determine a cache queue at the block IO layer 102 corresponding to the service level of the first user and a scheduling algorithm for scheduling the IO request of the first user, add the IO request of the first user to the determined cache queue at the block IO layer 102 corresponding to the service level of the first user, and schedule the IO request of the first user in the cache queue at the block IO layer 102 according to the determined scheduling algorithm for scheduling the IO request of the first user.

Step 203: The device driver layer 103 receives the scheduled IO request of the first user from the cache queue at the block IO layer 102 corresponding to the service level of the first user, and adds the scheduled IO request of the first user to a determined cache queue at the device driver layer 103 corresponding to the service level of the first user, for processing.

With reference to the file system 10 corresponding to FIG. 1, the device driver layer 103 may receive the scheduled IO request of the first user from the cache queue at the block IO layer 102 corresponding to the service level of the first user, and query for the third correspondence in the service level information base 104 according to the service level of the first user. The third correspondence is a correspondence between the service level of the user and the cache queue at the device driver layer 103.

Further, the device driver layer may query for the third correspondence in the service level information base according to the service level of the first user, to determine the cache queue at the device driver layer corresponding to the service level of the first user, and add the scheduled IO request of the first user to the determined cache queue at the device driver layer corresponding to the service level of the first user, for processing.

Optionally, the processing can be implemented using the cache queue at the device driver layer 103.

A cache queue exists at each of the virtual file system layer 101, the block IO layer 102, and the device driver layer 103. Different cache queues at one layer are corresponding to different user service levels. For example, a user request with a high service level can be added to a cache queue of a high level in order to be preferentially processed or so that more resources are allocated. A resource may be one or more of a computing resource, bandwidth, or cache space, which is not limited in this embodiment of the present disclosure. According to different service levels carried in IO requests of users, the IO requests of the users are added to corresponding cache queues for processing, which can meet different service level requirements for IO requests.

According to the IO request processing method provided in this embodiment of the present disclosure, a virtual file system layer 101 receives an IO request of a first user, and adds the IO request of the first user to a determined cache queue at the virtual file system layer 101 according to a service level of the first user. A block IO layer 102 receives the IO request of the first user from the determined cache queue at the virtual file system layer 101, adds the IO request of the first user to a cache queue at the block IO layer 102 corresponding to the service level of the first user, and schedules the IO request of the first user in the cache queue at the block IO layer 102 according to a determined scheduling algorithm for scheduling the IO request of the first user, and a device driver layer 103 receives the scheduled IO request of the first user from the cache queue at the block IO layer 102 corresponding to the service level of the first user, and adds the scheduled IO request of the first user to a determined cache queue at the device driver layer 103 corresponding to the service level of the first user, for processing. A first correspondence, a second correspondence, and a third correspondence that are corresponding to an IO request of a user are queried for according to a service level carried in the IO request of the user, and a cache queue corresponding to the IO request of the user is determined according to the first correspondence, the second correspondence, and third correspondence that are corresponding to the IO request of the user, thereby meeting different service level requirements for IO requests of users.

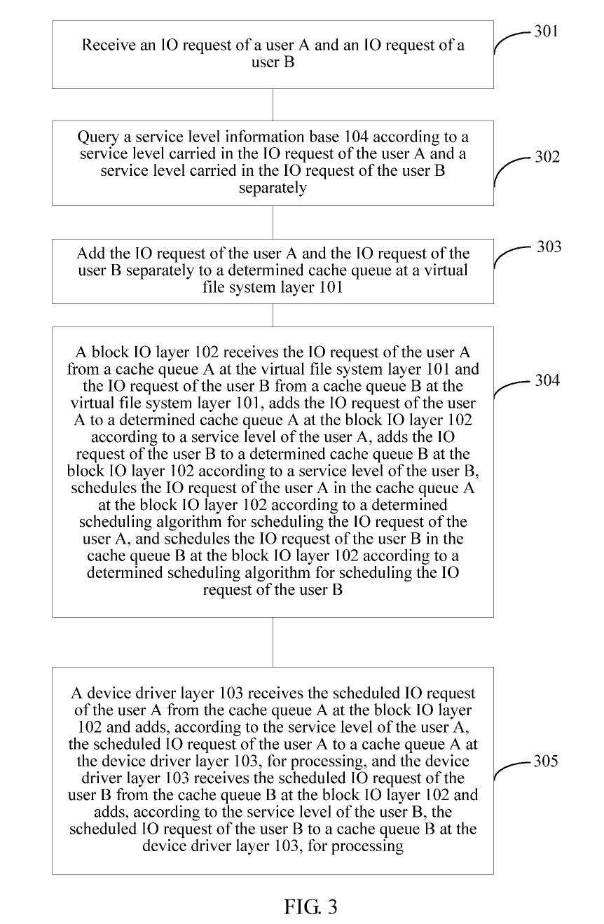

Another embodiment of the present disclosure provides an IO request processing method that is applied to a file system 10. Based on the embodiment corresponding to FIG. 2, this embodiment is described using an example in which a file server runs the file system 10 and receives an IO request of a user A and an IO request of a user B. Surely, it does not mean that the prevent disclosure is limited to processing of the IO request of the user A and the IO request of the user B. As shown in FIG. 3, the IO request processing method provided in this embodiment includes the following steps.

Step 301: Receive the IO request of the user A and the IO request of the user B.

With reference to the file system 10 corresponding to FIG. 1, the IO request of the user A and the IO request of the user B can be received using a virtual file system layer 101. The IO request of the user A carries a service level of the user A, and the IO request of the user B carriers a service level of the user B. The IO request of the user A needs to meet the service level of the user A, and the IO request of the user B needs to meet the service level of the user B. The service level of the user A is different from the service level of the user B.

Step 302: Query a service level information base 104 according to a service level carried in the IO request of the user A and a service level carried in the IO request of the user B separately.

With reference to the file system 10 corresponding to FIG. 1, the virtual file system layer 101 can separately query for a first correspondence in the service level information base 104 according to the IO request of the user A and the IO request of the user B. The first correspondence is a correspondence between a service level of a user and a cache queue at the virtual file system layer 101. Optionally, a first correspondence that is corresponding to the IO request of the user A and the IO request of the user B can be separately queried for in the service level information base 104 using a query method such as a sequence query, a dichotomic query, a hash table method, or a block query. Herein, a specific method used to implement a query in the service level information base 104 is not limited in this embodiment of the present disclosure.

Further, the service level information base 104 includes the first correspondence between the service level of a user and the cache queue at the virtual file system layer 101, a second correspondence among the service level of the user, a cache queue at a block IO layer 102, and a scheduling algorithm for scheduling the IO request of the user in the cache queue at the block IO layer 102, and a third correspondence between the service level of the user and a cache queue at a device driver layer 103. Optionally, a first correspondence, a second correspondence, and a third correspondence that are corresponding to an IO request of each user and stored in the service level information base 104 can be stored in the service level information base 104 in a form of list.

Step 303: Add the IO request of the user A and the IO request of the user B separately to a determined cache queue at a virtual file system layer 101.

With reference to the file system 10 corresponding to FIG. 1, the virtual file system layer 101 can separately query for a first correspondence in the service level information base 104 according to the service level of the user A and the service level of the user B, to determine a cache queue A at the virtual file system layer 101 corresponding to the service level of the user A and to determine a cache queue B at the virtual file system layer 101 corresponding to the service level of the user B, add the IO request of the user A to the cache queue A determined at the virtual file system layer 101, and add the IO request of the user B to the cache queue B determined at the virtual file system layer 101.

Step 304: A block IO layer 102 receives the IO request of the user A from a cache queue A at the virtual file system layer 101 and the IO request of the user B from a cache queue B at the virtual file system layer 101, adds the IO request of the user A to a determined cache queue A at the block IO layer 102 according to a service level of the user A, adds the IO request of the user B to a determined cache queue B at the block IO layer 102 according to a service level of the user B, schedules the IO request of the user A in the cache queue A at the block IO layer 102 according to a determined scheduling algorithm for scheduling the IO request of the user A, and schedules the IO request of the user B in the cache queue B at the block IO layer 102 according to a determined scheduling algorithm for scheduling the IO request of the user B.

With reference to the file system 10 corresponding to FIG. 1, the block IO layer 102 can receive the IO request of the user A in the cache queue A at the virtual file system layer 101 and receive the IO request of the user B in the cache queue B at the virtual file system layer 101. According to the service level of the user A, a second correspondence in the service level information base 104 is queried for to determine a cache queue A at the block IO layer 102 and a scheduling algorithm for scheduling the IO request of the user A in the cache queue A at the block IO layer 102. According to the service level of the user B, a second correspondence in the service level information base 104 is queried for to determine a cache queue B at the block IO layer 102 and a scheduling algorithm for scheduling the IO request of the user B in the cache queue B at the block IO layer 102. The second correspondence is a correspondence between a service level of a user, a cache queue at the block IO layer 102, and a scheduling algorithm for scheduling an IO request of the user in the cache queue at the block IO layer 102.

The block IO layer adds the IO request of the user A to the cache queue A at the block IO layer 102 and schedules the IO request of the user A in the cache queue A at the block 10 layer 102 according to a determined scheduling algorithm for scheduling the IO request of the user A, and adds the IO request of the user B to the cache queue B at the block IO layer 102 and schedules the IO request of the user B in the cache queue B at the block IO layer 102 according to a determined scheduling algorithm for scheduling the IO request of the user B. In this embodiment of the present disclosure, scheduling, according to a determined scheduling algorithm for scheduling the IO request of the user, IO requests of users in a cache queue that is determined at the block IO layer 102 may be any one of ordering the IO requests of the users or combining the IO requests of the users, or another operation on the IO requests of the users at the block IO layer in the art, which is not limited in this embodiment of the present disclosure.

Step 305: A device driver layer 103 receives the scheduled IO request of the user A from the cache queue A at the block IO layer 102 and adds, according to the service level of the user A, the scheduled IO request of the user A to a cache queue A at the device driver layer 103, for processing, and the device driver layer 103 receives the scheduled IO request of the user B from the cache queue B at the block IO layer 102 and adds, according to the service level of the user B, the scheduled IO request of the user B to a cache queue B at the device driver layer 103, for processing.

With reference to the file system 10 corresponding to FIG. 1, the device driver layer 103 receives the scheduled IO request of the user A from the cache queue A at the block IO layer 102, queries for a third correspondence in the service level information base 104 according to the service level of the user A, to determine the cache queue A at the device driver layer 103, and adds the scheduled IO request of the user A to the cache queue A at the device driver layer 103, for processing. The device driver layer 103 receives the scheduled IO request of the user B from the cache queue B at the block IO layer 102, queries a third correspondence in the service level information base 104 according to the service level of the user B, to determine the cache queue B at the device driver layer 103, and adds the scheduled IO request of the user B to the cache queue B at the device driver layer 103, for processing.

A cache queue exists at each of the virtual file system layer 101, the block IO layer 102, and the device driver layer 103. Different cache queues at one layer are corresponding to different user service levels. For example, a user request with a high service level can be added to a cache queue of a high level in order to be preferentially processed or so that more resources are allocated. A resource may be one or more of a computing resource, bandwidth, or cache space, which is not limited in this embodiment of the present disclosure.

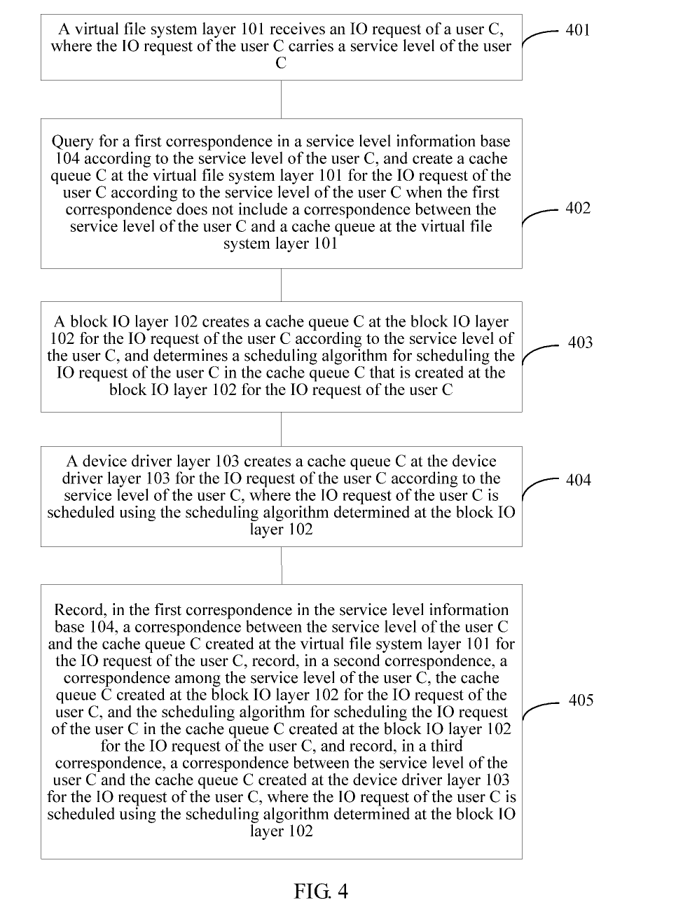

With reference to the foregoing embodiment, a specific creation process is shown in FIG. 4, and may include the following steps.

Step 401: A virtual file system layer 101 receives an IO request of a user C, where the IO request of the user C carries a service level of the user C.

The IO request of the user C carries a service level of the user C. The IO request of the user C needs to meet a service level requirement for the IO request of the user C.

Step 402: Query for a first correspondence in a service level information base 104 according to the service level of the user C, and create a cache queue C at the virtual file system layer 101 for the IO request of the user C according to the service level of the user C when the first correspondence does not include a correspondence between the service level of the user C and a cache queue at the virtual file system layer 101.

Step 403: A block IO layer 102 creates a cache queue C at the block IO layer 102 for the IO request of the user C according to the service level of the user C, and determines a scheduling algorithm for scheduling the IO request of the user C in the cache queue C that is created at the block IO layer 102 for the IO request of the user C.

Step 404: A device driver layer 103 creates a cache queue C at the device driver layer 103 for the IO request of the user C according to the service level of the user C, where the IO request of the user C is scheduled using the scheduling algorithm determined at the block IO layer 102.

With reference to the specific creation process, after the corresponding cache queues are created, for the IO request of the user C, at the virtual file system layer 101, the block IO layer 102, and the device driver layer 103 separately, the process may further include the following step.

Step 405: Record, in the first correspondence in the service level information base 104, a correspondence between the service level of the user C and the cache queue C created at the virtual file system layer 101 for the IO request of the user C, record, in a second correspondence, a correspondence among the service level of the user C, the cache queue C created at the block IO layer 102 for the IO request of the user C, and the scheduling algorithm for scheduling the IO request of the user C in the cache queue C created at the block IO layer 102 for the IO request of the user C, and record, in a third correspondence, a correspondence between the service level of the user C and the cache queue C created at the device driver layer 103 for the IO request of the user C, where the IO request of the user C is scheduled using the scheduling algorithm determined at the block IO layer 102.

According to the IO request processing method provided in this embodiment of the present disclosure, a service level information base 104 is queried for according to a service level carried in an IO request of a user, to determine a cache queue at a virtual file system layer 101, a block IO layer 102, a device driver layer 103 separately, and an algorithm for scheduling the IO request of the user in the determined cache queue at the block IO layer 102, thereby meeting different service level requirements for IO requests of users.

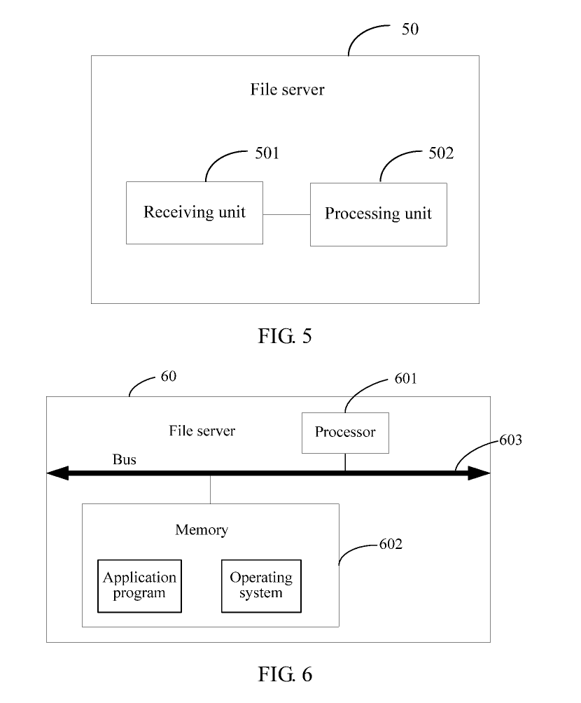

An embodiment of the present disclosure provides a file server 50 in FIG. 5, where the file server 50 runs a file system 10, and the file system 10 includes a virtual file system layer 101, a block IO layer 102, and a device driver layer 103. The file system 10 further includes a service level information base 104, and the service level information base 104 includes a first correspondence between a service level of a user and a cache queue at the virtual file system layer 101, a second correspondence among the service level of the user, a cache queue at the block IO layer 102, and a scheduling algorithm for scheduling an IO request of the user in the cache queue at the block IO layer 102, and a third correspondence between the service level of the user and a cache queue at the device driver layer 103. As shown in FIG. 5, the file server 50 includes a receiving unit 501 configured to receive an IO request of a first user using the virtual file system layer 101, where the IO request of the first user carries a service level of the first user, and a processing unit 502 configured to query for the first correspondence in the service level information base 104 according to the service level of the first user, to determine a cache queue at the virtual file system layer 101 corresponding to the service level of the first user, and add the IO request of the first user to the determined cache queue at the virtual file system layer 101.

The receiving unit 501 is further configured to receive, using the block IO layer 102, the IO request of the first user from the determined cache queue at the virtual file system layer 101.

The processing unit 502 is further configured to query for the second correspondence in the service level information base 104 according to the service level of the first user, to determine a cache queue at the block IO layer 102 corresponding to the service level of the first user and a scheduling algorithm for scheduling the IO request of the first user, add the IO request of the first user to the determined cache queue at the block IO layer 102 corresponding to the service level of the first user, and schedule the IO request of the first user in the cache queue at the block IO layer 102 according to the determined scheduling algorithm for scheduling the IO request of the first user.

The receiving unit 501 is further configured to receive, using the device driver layer 103, the scheduled IO request of the first user from the cache queue at the block IO layer 102 corresponding to the service level of the first user.

The processing unit 502 is further configured to query for the third correspondence in the service level information base 104 according to the service level of the first user, to determine a cache queue at the device driver layer 103 corresponding to the service level of the first user, and add the scheduled IO request of the first user to the determined cache queue at the device driver layer 103 corresponding to the service level of the first user, for processing.

Optionally, the receiving unit 501 is further configured to receive an IO request of a second user using the virtual file system layer 101, where the IO request of the second user carries a service level of the second user.

The processing unit 502 is further configured to query for the first correspondence in the service level information base 104 according to the service level of the second user, and create a cache queue for the IO request of the second user at the virtual file system layer 101 according to the service level of the second user when the first correspondence does not include a correspondence between the service level of the second user and the cache queue at the virtual file system layer 101.

The processing unit 502 is further configured to create, using the block IO layer 102, a cache queue at the block IO layer 102 for the IO request of the second user according to the service level of the second user, and determine a scheduling algorithm for scheduling the IO request of the second user in the cache queue that is created at the block IO layer 102 for the IO request of the second user.

The processing unit 502 is further configured to create, using the device driver layer 103, a cache queue at the device driver layer 103 for the IO request of the second user according to the service level of the second user, where the IO request of the second user is scheduled using the scheduling algorithm determined at the block IO layer 102.

Optionally, the file server 50 further includes a storage unit 503 (not shown) configured to record, in the first correspondence in the service level information base 104, a correspondence between the service level of the second user and the cache queue created at the virtual file system layer 101 for the IO request of the second user, record, in the second correspondence, a correspondence among the service level of the second user, the cache queue created at the block IO layer 102 for the IO request of the second user, and the scheduling algorithm for scheduling the IO request of the second user in the cache queue that is created at the block IO layer 102 for the IO request of the second user, and record, in the third correspondence, a correspondence between the service level of the second user and the cache queue created at the device driver layer 103 for the IO request of the second user scheduled using the scheduling algorithm determined at the block IO layer 102.

According to the file server provided in this embodiment of the present disclosure, a virtual file system layer 101 receives an IO request of a first user, and adds the IO request of the first user to a determined cache queue at the virtual file system layer 101 if a first correspondence corresponding to the IO request of the first user can be found according to a service level of the first user, a block IO layer 102 receives the IO request of the first user from the determined cache queue at the virtual file system layer 101, adds the IO request of the first user to a determined cache queue at the block IO layer 102 corresponding to the service level of the first user, and schedules the IO request of the first user in the cache queue at the block IO layer 102 according to a determined scheduling algorithm for scheduling the IO request of the first user, and a device driver layer 103 receives the scheduled IO request of the first user from the cache queue at the block IO layer 102 corresponding to the service level of the first user, and adds the scheduled IO request of the first user to a determined cache queue at the device driver layer 103 corresponding to the service level of the first user, for processing. A first correspondence, a second correspondence, and a third correspondence that are corresponding to an IO request of a user are queried for according to a service level carried in the IO request of the user, a cache queue corresponding to the IO request of the user is determined according to the first correspondence, the second correspondence, and the third correspondence that are corresponding to the IO request of the user, and the IO request of the user is added to the corresponding cache queue, thereby meeting different service level requirements for IO requests of users.

Another embodiment of the present disclosure provides a file server 60 in FIG. 6, where the file server 60 runs a file system 10, and the file system 10 includes a virtual file system layer 101, a block IO layer 102, and a device driver layer 103. The file system 10 further includes a service level information base 104, and the service level information base 104 includes a first correspondence between a service level of a user and a cache queue at the virtual file system layer 101, a second correspondence among the service level of the user, a cache queue at the block IO layer 102, and a scheduling algorithm for scheduling an IO request of the user in the cache queue at the block IO layer 102, and a third correspondence between the service level of the user and a cache queue at the device driver layer 103. As shown in FIG. 6, the file server 60 may be embedded into a micro-processing computer or may be a micro-processing computer, for example, a portable device such as a general-purpose computer, a customized machine, a mobile terminal, or a tablet machine. The file server 60 includes at least one processor 601, a memory 602, and a bus 603, where the at least one processor 601 and the memory 602 are connected and communicate with each other using the bus 603.

The bus 603 may be an industry standard architecture (ISA) bus, a Peripheral Component Interconnect (PCI) bus, an extended industry standard architecture (EISA) bus, or the like. The bus 603 may be classified into an address bus, a data bus, a control bus, or the like. For ease of denotation, the bus 603 is represented using only one thick line in FIG. 6, which, however, does not indicate that there is only one bus or only one type of bus.

The memory 602 is configured to execute program code for the solution in the present disclosure, where the program code for executing the solution in the present disclosure is stored in the memory 602, and is controlled and executed by the processor 601.

The memory 602 may be a read-only memory (ROM) or another type of static storage device that can store static information and instructions, a random access memory (RAM) or another type of dynamic storage device that can store information and instructions, an electrically erasable programmable read-only memory (EEPROM), a compact disc read-only memory (CD-ROM) or another compact disk storage medium, compact disc storage medium (including a compact disc, a laser disc, an optical disc, a digital versatile disc, a BLU-RAY DISC, and the like), magnetic disk storage medium or another magnetic storage device, or any other medium that can be used to carry or store expected program code in an instruction or data structure form and that can be accessed by a computer, which is not limited thereto though. These memories are connected to the processor 601 using the bus 603.

The processor 601 may be a CPU or an application-specific integrated circuit (ASIC), or is configured as one or more integrated circuits that implement this embodiment of the present disclosure.

The processor 601 is configured to invoke the program code in the memory 602, and in a possible implementation manner, implement the following functions when the foregoing program code is executed by the processor 601.

The processor 601 is configured to receive an IO request of a first user using the virtual file system layer 101, where the IO request of the first user carries a service level of the first user, query for the first correspondence in the service level information base 104 according to the service level of the first user, to determine a cache queue at the virtual file system layer 101 corresponding to the service level of the first user, and add the IO request of the first user to the determined cache queue at the virtual file system layer 101.

The processor 601 is further configured to receive the IO request of the first user from the determined cache queue at the virtual file system layer 101 using the block IO layer 102, query for the second correspondence in the service level information base 104 according to the service level of the first user, to determine a cache queue at the block IO layer 102 corresponding to the service level of the first user and a scheduling algorithm for scheduling the IO request of the first user, add the IO request of the first user to the determined cache queue at the block IO layer 102 corresponding to the service level of the first user, and schedule the IO request of the first user in the cache queue at the block IO layer 102 according to the determined scheduling algorithm for scheduling the IO request of the first user.

The processor 601 is further configured to receive, using the device driver layer 103, the scheduled IO request of the first user from the cache queue at the block IO layer 102 corresponding to the service level of the first user, query for the third correspondence in the service level information base 104 according to the service level of the first user, to determine a cache queue at the device driver layer 103 corresponding to the service level of the first user, and add the scheduled IO request of the first user to the determined cache queue at the device driver layer 103 corresponding to the service level of the first user, for processing.

Optionally, the processor 601 is further configured to receive an IO request of a second user using the virtual file system layer 102, where the IO request of the second user carries a service level of the second user.

The processor 601 is further configured to query for the first correspondence in the service level information base 104 according to the service level of the second user, and when the first correspondence does not include a correspondence between the service level of the second user and the cache queue at the virtual file system layer 101, create a cache queue at the virtual file system layer 101 for the IO request of the second user according to the service level of the second user.

The processor 601 is further configured to create, using the block IO layer 102, a cache queue at the block IO layer 102 for the IO request of the second user according to the service level of the second user, and determine a scheduling algorithm for scheduling the IO request of the second user in the cache queue that is created at the block IO layer 102 for the IO request of the second user.

The processor 601 is further configured to create, using the device driver layer 103, a cache queue at the device driver layer 103 for the IO request of the second user according to the service level of the second user, where the IO request of the second user is scheduled using the scheduling algorithm determined at the block IO layer.

Optionally, the memory 602 is further configured to record, in the first correspondence in the service level information base 104, a correspondence between the service level of the second user and the cache queue created at the virtual file system layer 101 for the IO request of the second user, record, in the second correspondence, a correspondence among the service level of the second user, the cache queue created at the block IO layer 102 for the IO request of the second user, and the scheduling algorithm for scheduling the IO request of the second user in the cache queue that is created at the block IO layer 102 for the IO request of the second user, and record, in the third correspondence, a correspondence between the service level of the second user and the cache queue created at the device driver layer 103 for the IO request of the second user scheduled using the scheduling algorithm determined at the block IO layer.

According to the file server provided in this embodiment of the present disclosure, a processor 601 receives an IO request of a first user using a virtual file system layer 101, and adds the IO request of the first user to a determined cache queue at the virtual file system layer 101 if a first correspondence corresponding to the IO request of the first user can be found according to a service level of the first user, receives, using a block IO layer 102, the IO request of the first user from the determined cache queue at the virtual file system layer 101, adds the IO request of the first user to a determined cache queue at the block IO layer 102 corresponding to the service level of the first user, and schedules the IO request of the first user in the cache queue at the block IO layer 102 according to a determined scheduling algorithm for scheduling the IO request of the first user, and receives, using a device driver layer 103, the scheduled IO request of the first user from the cache queue at the block IO layer 102 corresponding to the service level of the first user, and adds the scheduled IO request of the first user to a determined cache queue at the device driver layer 103 corresponding to the service level of the first user, for processing, thereby meeting different service level requirements for IO requests of users.

The embodiments of the present disclosure may be applied to a scenario in which IO requests of different users carry different service levels, where processing is performed according to the method in the embodiments of the present disclosure, or may be applied to a scenario in which an IO request of one user carries different service levels, where processing is performed according to the method in the embodiments of the present disclosure, or may be applied to a scenario in which IO requests of different users carry one service level, where processing is performed according to the method in the embodiments of the present disclosure. In the embodiments of the present disclosure, an IO request of a user is processed according to a service level carried in the IO request of the user.

With descriptions of the foregoing embodiments, a person skilled in the art may clearly understand that the present disclosure may be implemented using hardware, firmware, or a combination thereof. The foregoing functions may be stored in a computer readable medium or transmitted as one or more instructions or code in the computer readable medium when the present disclosure is implemented using software. The computer readable medium includes a computer storage medium and a communications medium, where the communications medium includes any medium that enables a computer program to be transmitted from one place to another. The storage medium may be any available medium accessible to a computer. The following is taken as an example but is not limited. The computer readable medium may include a RAM, a ROM, an EEPROM, a CD-ROM or other compact disk storage, a magnetic disk storage medium, or other magnetic storage device, or any other medium that can be used to carry or store expected program code in a form of command or data structure and can be accessed by a computer. In addition, any connection may be appropriately defined as a computer readable medium. For example, if software is transmitted from a website, a server, or another remote source using a coaxial cable, an optical fiber/cable, a twisted pair, a digital subscriber line (DSL), or a wireless technology such as infrared ray, radio, or microwave, the coaxial cable, optical fiber/cable, twisted pair, or wireless technology such as infrared ray, radio, or microwave are included in fixation of a medium to which they belong. For example, a disk and a disc that are used by the present disclosure include a compact disc (CD), a laser disc, a compact disk, a digital versatile disc (DVD), a floppy disk, and a BLU-RAY DISC, where the disk generally copies data magnetically, and the disc copies data optically using laser. The foregoing combination should also be included in the protection scope of the computer readable medium.

What is claimed is:

1. An input/output (IO) request processing method applied to a file system, wherein the file system comprises a virtual file system layer, a block IO layer, a device driver layer, and a service level information base, wherein the service level information base comprises a first correspondence between a service level of a user and a cache queue at the virtual file system layer, a second correspondence among the service level of the user, a cache queue at the block IO layer, and a scheduling algorithm for scheduling an IO request of the user in the cache queue at the block IO layer, and a third correspondence between the service level of the user and a cache queue at the device driver layer, and wherein the method comprises:
receiving, by the virtual file system layer, an IO request of a first user, wherein the IO request of the first user carries a service level of the first user;
querying for the first correspondence in the service level information base according to the service level of the first user, to determine a cache queue at the virtual file system layer corresponding to the service level of the first user;
adding the IO request of the first user to the determined cache queue at the virtual file system layer;
receiving, by the block IO layer, the IO request of the first user from the determined cache queue at the virtual file system layer;
querying for the second correspondence in the service level information base according to the service level of the first user, to determine a cache queue at the block IO layer corresponding to the service level of the first user and a scheduling algorithm for scheduling the IO request of the first user;
adding the IO request of the first user to the determined cache queue at the block IO layer corresponding to the service level of the first user;
scheduling the IO request of the first user in the cache queue at the block IO layer according to the determined scheduling algorithm for scheduling the IO request of the first user;
receiving, by the device driver layer, the scheduled IO request of the first user from the cache queue at the block IO layer corresponding to the service level of the first user;
querying for the third correspondence in the service level information base according to the service level of the first user, to determine a cache queue at the device driver layer corresponding to the service level of the first user; and
adding the scheduled IO request of the first user to the determined cache queue at the device driver layer corresponding to the service level of the first user, for processing.

2. The method according to claim 1, further comprising:
receiving, by the virtual file system layer, an IO request of a second user, wherein the IO request of the second user carries a service level of the second user;
querying for the first correspondence in the service level information base according to the service level of the second user;
creating a cache queue at the virtual file system layer for the IO request of the second user according to the service level of the second user when the first correspondence does not comprise a correspondence between the service level of the second user and the cache queue at the virtual file system layer;
creating, by the block IO layer, a cache queue at the block IO layer for the IO request of the second user according to the service level of the second user;
determining a scheduling algorithm for scheduling the IO request of the second user in the cache queue that is created at the block IO layer for the IO request of the second user; and
creating, by the device driver layer, a cache queue at the device driver layer for the IO request of the second user according to the service level of the second user, wherein the IO request of the second user is scheduled using the scheduling algorithm determined at the block IO layer.

3. The method according to claim 2, further comprising:
recording, in the first correspondence in the service level information base, a correspondence between the service level of the second user and the cache queue created at the virtual file system layer for the IO request of the second user;
recording, in the second correspondence, a correspondence among the service level of the second user, the cache queue created at the block IO layer for the IO request of the second user, and the scheduling algorithm for scheduling the IO request of the second user in the cache queue that is created at the block IO layer for the IO request of the second user; and
recording, in the third correspondence, a correspondence between the service level of the second user and the cache queue created at the device driver layer for the IO request of the second user scheduled using the scheduling algorithm determined at the block IO layer.

4. A file server, wherein the file server runs a file system, the file system comprises a virtual file system layer, a block input/output (IO) layer, a device driver layer, and a service level information base, wherein the service level information base comprises a first correspondence between a service level of a user and a cache queue at the virtual file system layer, a second correspondence among the service level of the user, a cache queue at the block IO layer, and a scheduling algorithm for scheduling an IO request of the user in the cache queue at the block IO layer, and a third correspondence between the service level of the user and a cache queue at the device driver layer, and wherein the file server comprises:
a processor;
a bus; and
a memory,
wherein the processor and the memory are connected using the bus, and
wherein the processor is configured to:
receive an IO request of a first user using the virtual file system layer, wherein the IO request of the first user carries a service level of the first user;
query for the first correspondence in the service level information base according to the service level of the first user, to determine a cache queue at the virtual file system layer corresponding to the service level of the first user;
add the IO request of the first user to the determined cache queue at the virtual file system layer;
receive the IO request of the first user from the determined cache queue at the virtual file system layer using the block IO layer;
query for the second correspondence in the service level information base according to the service level of the first user, to determine a cache queue at the block IO layer corresponding to the service level of the first user and a scheduling algorithm for scheduling the IO request of the first user;
add the IO request of the first user to the determined cache queue at the block IO layer corresponding to the service level of the first user;
schedule the IO request of the first user in the cache queue at the block IO layer according to the determined scheduling algorithm for scheduling the IO request of the first user;
receive, using the device driver layer, the scheduled IO request of the first user from the cache queue at the block IO layer corresponding to the service level of the first user;
query for the third correspondence in the service level information base according to the service level of the first user, to determine a cache queue at the device driver layer corresponding to the service level of the first user; and
add the scheduled IO request of the first user to the determined cache queue at the device driver layer corresponding to the service level of the first user, for processing.

5. The file server according to claim 4, wherein the processor is further configured to:
receive an IO request of a second user using the virtual file system layer, wherein the IO request of the second user carries a service level of the second user;
query for the first correspondence in the service level information base according to the service level of the second user;
create a cache queue at the virtual file system layer for the IO request of the second user according to the service level of the second user when the first correspondence does not comprise a correspondence between the service level of the second user and the cache queue at the virtual file system layer;
create, using the block IO layer, a cache queue at the block IO layer for the IO request of the second user according to the service level of the second user;
determine a scheduling algorithm for scheduling the IO request of the second user in the cache queue that is created at the block IO layer for the IO request of the second user; and
create, using the device driver layer, a cache queue at the device driver layer for the IO request of the second user according to the service level of the second user, wherein the IO request of the second user is scheduled using the scheduling algorithm determined at the block IO layer.

6. The file server according to claim 5, wherein the memory is configured to:
record, in the first correspondence in the service level information base, a correspondence between the service level of the second user and the cache queue created at the virtual file system layer for the IO request of the second user;
record, in the second correspondence, a correspondence among the service level of the second user, the cache queue created at the block IO layer for the IO request of the second user, and the scheduling algorithm for scheduling the IO request of the second user in the cache queue that is created at the block IO layer for the IO request of the second user; and
record, in the third correspondence, a correspondence between the service level of the second user and the cache queue created at the device driver layer for the IO request of the second user scheduled using the scheduling algorithm determined at the block IO layer.
